(19) United States
(12) Patent Application Publication
(10) Pub. No.: US 2018/0358149 A1
(43) Pub. Date: Dec. 13, 2018

(54) MULTIFUNCTION LOW PROFILE INSTRUMENT CONNECTION CABLE

(71) Applicant: Hollis Matthew Tapp, Cedar Park, TX (US)

(72) Inventor: Hollis Matthew Tapp, Cedar Park, TX (US)

(21) Appl. No.: 16/006,609

(22) Filed: Jun. 12, 2018

Related U.S. Application Data
(60) Provisional application No. 62/518,432, filed on Jun. 12, 2017.

(51) Int. Cl. H01B 7/00

(52) U.S. Cl. CPC H01B 7/009; H01R 24/20; H01B 7/0045

(57) ABSTRACT

A cable having a plurality of conductors, wherein one or more of the conductors is connected to a receptacle connector built into a main cable trunk of the cable, and wherein one or more of the conductors continues in the cable past the receptacle connector.

### CROSS-REFERENCE TO RELATED APPLICATION

This application claims the benefit of the filing date of U.S. Provisional Patent Application 62/518,432, filed Jun. 12, 2017, which is hereby incorporated by reference.

### TECHNICAL FIELD

The present disclosure is directed, in general, to cables and connectors for audio and musical equipment, including but not limited to guitar cables.

### BACKGROUND OF THE DISCLOSURE

Cable management can be difficult, particularly in the context of cabling between musical instruments, sound equipment, and other devices. Improved cabling is desirable.

### SUMMARY OF THE DISCLOSURE

Various disclosed embodiments include cables for use in audio and musical systems that include breakout connectors for more efficient and effective cable management. One disclosed embodiment includes a cable having a plurality of conductors, wherein one or more of the conductors is connected to a receptacle connector built into a main cable trunk of the cable, and wherein one or more of the conductors continues in the cable past the receptacle connector.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases may be provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWING

For a more complete understanding of the present disclosure, and the advantages thereof, reference is now made to the following descriptions taken in conjunction with the accompanying drawings, wherein like numbers designate like objects, and in which:

FIGS. 1, 2, and 3 illustrate examples of a cable in accordance with disclosed embodiments.

### DETAILED DESCRIPTION

The figures discussed below and filed herewith, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

As advancing technology impacts the fields of entertainment. Musicians and performers desire and are often required to employ more and more devices. Each of these devices requires connection, usually via connecting cables. Routing all of these cables to and from the performer's physical position can be challenging in that too many external entanglements can negatively impact the performer's ability, and each of these cables represent a multitude of potential failure points. Two significant examples of this are the use of in-ear monitoring equipment and the growing use of two-way instrument effects, both sending and receiving audio signals to and from remote locations.

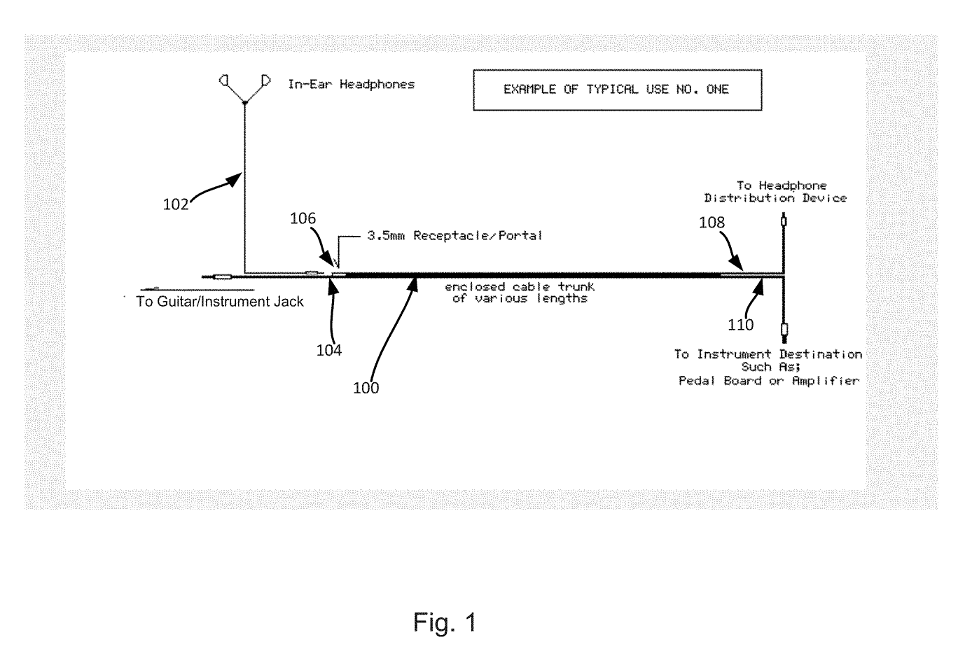

FIG. 1 illustrates one example of a cable in accordance with disclosed embodiments. Disclosed embodiments include a single cable 100 with two or more discreet internal cable components. For example, in FIG. 1, cable 100 has components for in-ear headphones 102, guitar/instrument jack 104, headphone distribution device 108, and instrument destination 110 (such as a pedal board, sound board, amplifier, etc.).

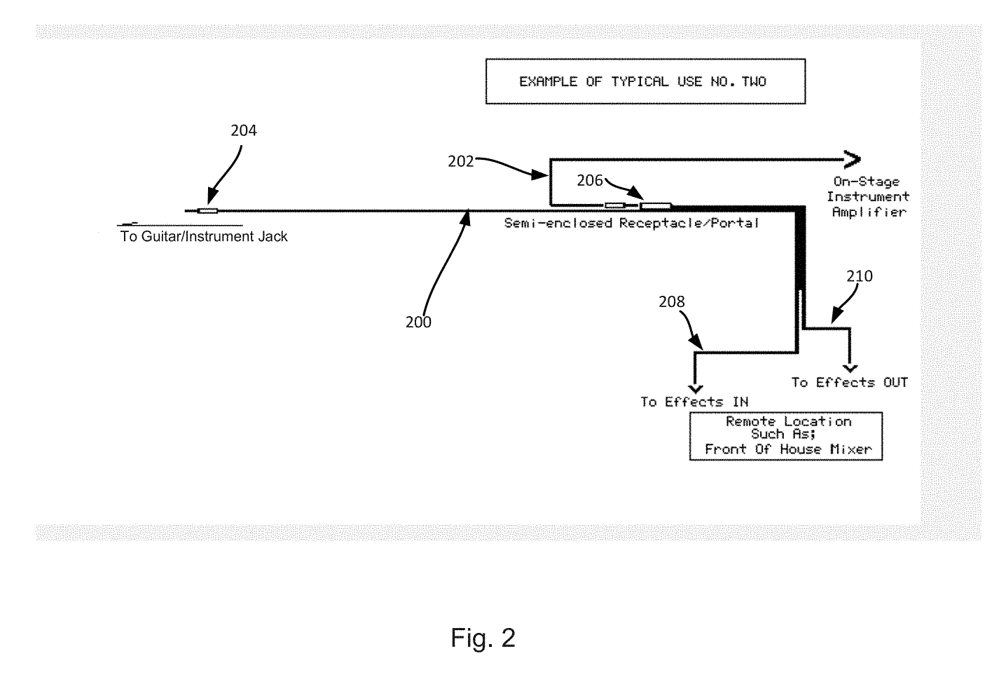

FIG. 2 illustrates another example of a cable in accordance with disclosed embodiments. Disclosed embodiments include a single cable 200 with two or more discreet internal cable components. For example, in FIG. 2, cable 200 has components for an on-stage instrument amplifier 202, guitar/instrument jack 204, an effects input 208, and an effects output 210.

The internal cable components are accessed by virtue of any number of breakout connectors, such as a 3.5 mm receptacle/portal/jack 106 or semi-enclosed receptacle/portal 206. One or more of these connectors are implemented as a receptacle connector built into the main cable trunk.

The connecting device cable can plug into the actual cable trunk via the connector portal. Thus, the number of appendages is reduced and adverse pull or restriction is reduced or eliminated, allowing a more comfortable state.

The example of FIG. 1 shows a typical use that might include an in-ear monitor system and performer's electric guitar signal included in one cable trunk. The in-ear device would plug into the receptacle portal on the cable trunk and its signal would travel in the opposite direction of the electric guitar. The electric guitar is outputting to a remote amplifier and the in-ear monitor is receiving audio from a remote location and delivering directly to the ear. Disclosed embodiments therefore eliminate the need for two cables and/or the existence of Y-cables in the vicinity of the performers head, back, or feet.

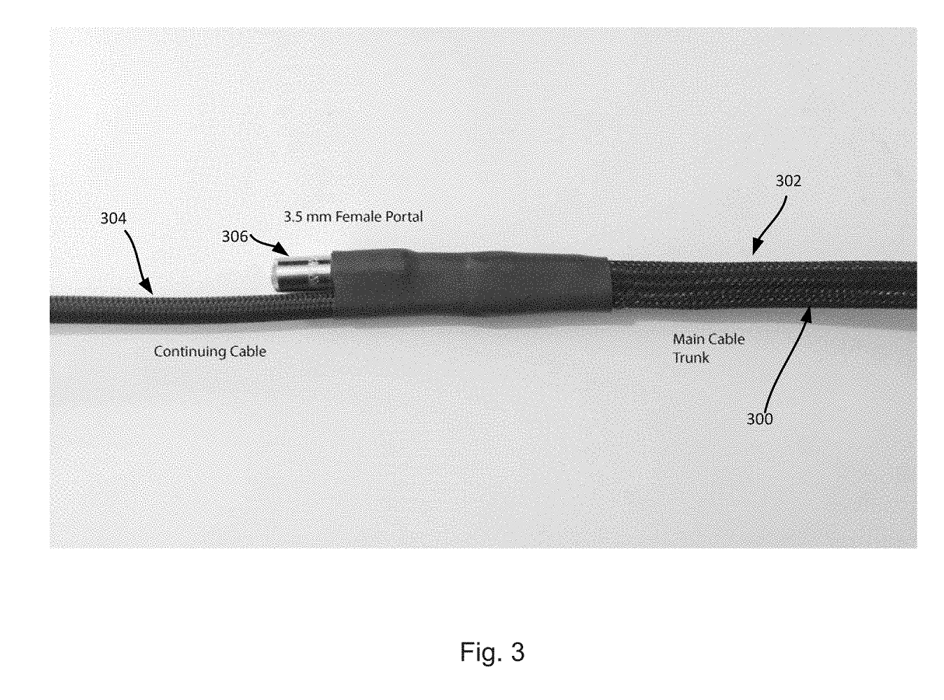

FIG. 3 illustrates an example of a cable 300 in accordance with disclosed embodiments. Cable 300 includes a main cable trunk 302. Some of the connections of main cable trunk 302 are connected to the receptacle connector 306, while some of the connections of main cable trunk 302 continue in continuing cable portion 304.

Not that, in specific embodiments, the wires connected to receptacle connector 306 do not continue in continuing cable portion 304. That is, the wires or other connections of main cable truck 302 are specifically dedicated to the receptacle connector, and those cables are not then connected in parallel with another connection further along continuing cable portion 304.

Those skilled in the art will recognize that, for simplicity and clarity, the full structure and operation of all cables or connectors for use with the present disclosure is not being depicted or described herein. Instead, only so much of a cable or connector as is unique to the present disclosure or necessary for an understanding of the present disclosure is depicted and described. The remainder of the construction and operation of cables in accordance with disclosed embodiments may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element is an essential element which must be included in the claim scope: the scope of patented subject matter is defined only by the allowed claims. Moreover, none of these claims are intended to invoke 35 USC § 112(f) unless the exact words “means for” are followed by a participle.

What is claimed is:

1. A cable having a plurality of conductors,
wherein one or more of the conductors is connected to a receptacle connector built into a main cable trunk of the cable, and
wherein one or more of the conductors continues in the cable past the receptacle connector.

2. The cable of claim 1, wherein the conductors connected to the receptacle connector do not continue in the cable past the receptacle connector.

3. The cable of claim 1, wherein each conductor is connected to only a single input connection and a single output connection.
